(19) United States
(12) Patent Application Publication
(10) Pub. No.: US 2016/0369526 A1
(43) Pub. Date: Dec. 22, 2016

(54) Magnet for keys

(71) Applicant: Vincent Vinh Ho, San Francisco, CA (US)

(72) Inventor: Vincent Vinh Ho, San Francisco, CA (US)

(21) Appl. No.: 14/745,372

(22) Filed: Jun. 19, 2015

(51) Int. Cl. E05B 19/00; H01F 7/02

(52) U.S. Cl. CPC E05B 19/00; H01F 7/0205

(57) ABSTRACT

A new magnet with a peel sticky back to keep keys on a keys ring organized, clean and do not jingle. The magnet installed on any key by a peel sticky back without need to change the key itself. The present invention can prevent keys from jingling by having all your keys stuck together.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Field of the Invention

This invention relates generally to the magnet used to organize keys.

Description of the Related Art

To organize keys there are many patent granted for inventions related to magnetic keys, in all these keys the magnet built in the keys like the patent number 20040079125 or the keys organized by a magnet ring, so that we invented a magnet can be installed on any key by sticker without change the key itself. What the present invention does is magnetize the keys so that they stick together and stay organized. Since they are stuck together, they are organized and do not jingle.

### BRIEF SUMMARY OF THE INVENTION

In one aspect the present invention designed to keep keys organized by having them stick to one another. The present invention can prevent keys from jingling by having all your keys stuck together.

In another aspect the present invention that is a magnet for keys can be installed easily on any key without need to be built in in this key.

### DESCRIPTION OF THE DRAWINGS

For a more complete understanding of the present invention, reference is now made to the following descriptions:

FIG. 1 Show how the keys work using the magnet. You go from a jumble of keys to an organized set.

FIG. 2 Show how to install the magnet on the key using a peel sticky back.

FIG. 3 The Positive Magnetic pole and the Negative Magnetic pole of the present invention.

### REFERENCE NUMERALS IN THE DRAWINGS

For a more complete understanding of parts names of the present invention, reference is now made to the following descriptions:
1—Keys.
1A—The set of jumble keys.
1B—The set of organized keys.
2—3M peel Sticky back.
3—Magnet.
3A—Positive magnetic pole.
3B—Negative magnetic pole.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

The present invention is a magnet can be installed easily on any key. You do this with all of your keys. Once they are on a ring together, the keys will stick together due to the magnets, thus keeping them clean and organized. Also, because your keys are now stuck together, they no longer jingle.

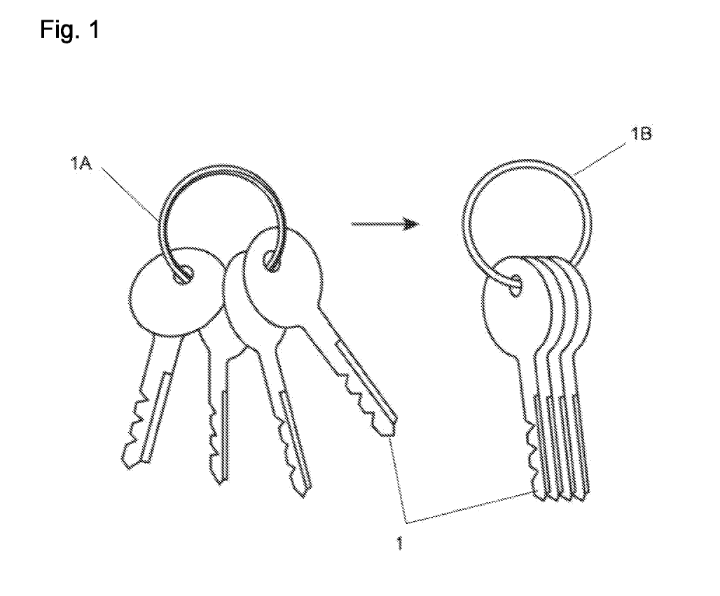

referring to FIG. 1 this is how the keys 1 work after we use the magnet 3. we can go from a jumble of keys 1A to an organized set 1B.

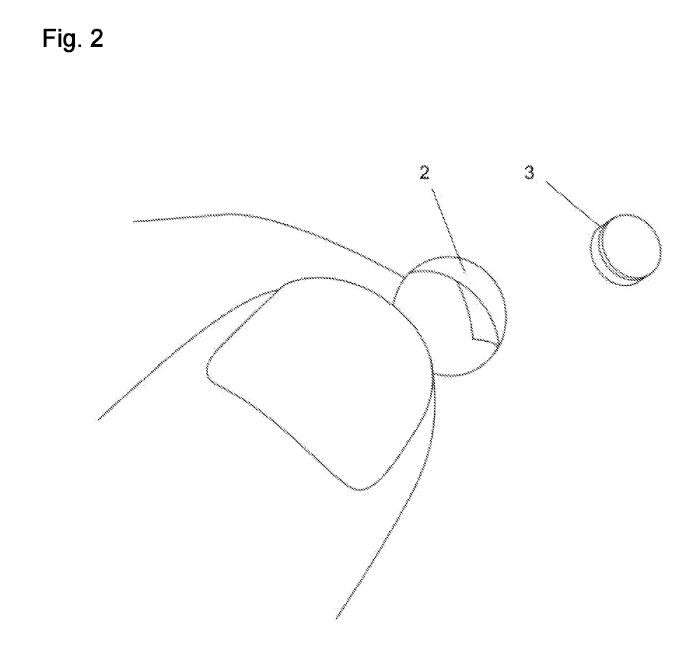

Referring to FIG. 2 this is how we can install the magnet 3 on the keys 1 using the peel Sticky back 2. Just we peel the magnet 3 from the packaging and we use the peel Sticky back 2 to stick them onto keys 1.

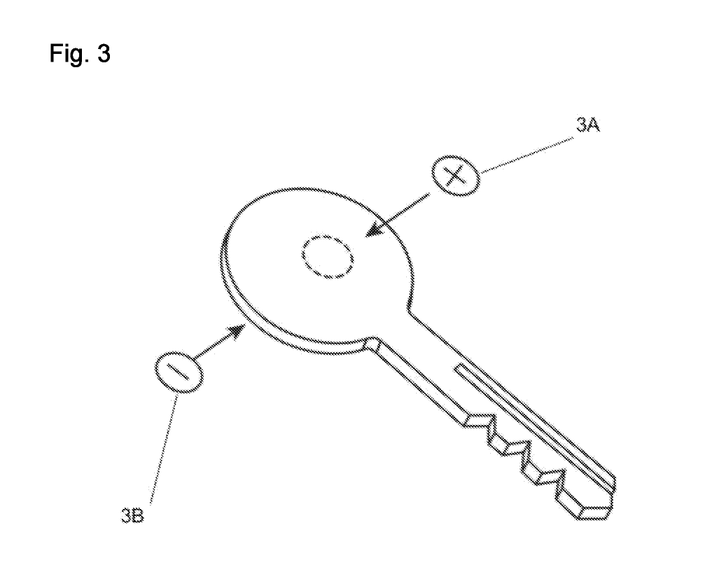

Referring to FIG. 3 basically, with magnets 3 you peel and stick magnets 3 one positive 3A and one negative 3B onto opposite sides of your key 1 head. so we can organize the keys 1 we have to install two magnet poles 3, Positive Magnetic pole 3A on one side of the key 1 and Negative Magnetic pole 3B on the other side of the key 1. We install the negative magnetic pole 3B on the first key 1 to face the positive magnetic pole 3A on the second key 1 so they can stick each other at the end.

The magnets 3 are N42 Grade Neodymium Magnets 3 with 3M peel sticky back 2. We engraved them with + and − to indicate positive 3A and negative magnets 3B.

The dimensions of each magnet 3 are:
Diameter—9.5 mm.
Thickness—0.8 mm.
3M Adhesive Back.
Engraved with either a + or − depending on the exposed magnetic pole.

What is claimed is:

1. A magnet with a peel sticky back for keys to keep keys organized by having them stick to one another. The magnet can prevent keys from jingling by having all your keys stuck together.

2. A magnet for keys can be installed easily on any key by a peel sticky back without need to be built in in the key. we install the magnet by peeling and stick the sticky back of the magnets one positive and one negative onto opposite sides of a key head. so we can organize the keys we have to install two magnet poles, Positive Magnetic pole on one side of the key and Negative Magnetic pole on the other side of the key. We install the negative magnetic pole on the first key to face the positive magnetic pole on the second key so they can stick each other at the end.

3. The magnets are N42 Grade Neodymium Magnets 3 with 3M peel sticky back. We engraved them with + and − to indicate positive and negative magnets. The dimensions of each magnet 3 are: Diameter—9.5 mm. Thickness—0.8 mm. 3M Adhesive Back. Engraved with either a + or − depending on the exposed magnetic pole.
